(19) United States
(12) Patent Application Publication
(10) Pub. No.: US 2006/0207138 A1
(43) Pub. Date: Sep. 21, 2006

(54) Photoelectron luminescence doorplate

(76) Inventor: Se Kit Yuen, Kowloon (HK)

Correspondence Address: AKERMAN SENTERFITT, P.O. BOX 3188, WEST PALM BEACH, FL, 33402-3188, US

(21) Appl. No.: 11/199,065

(22) Filed: Aug. 8, 2005

(30) Foreign Application Priority Data
Jan. 21, 2005 (CN) 200520003333.6

(51) Int. Cl. G09F 13/22

(52) U.S. Cl. 40/544

(57) ABSTRACT

The present utility model provides photoelectron luminescence doorplate comprising a seat body provided with at least one luminous body and a set of chargeable storage batteries therein; a cover; a solar-energy converting sensitive plate flexibly connected to an upper end of said seat body; a drive circuit for said luminous body electrically connected with an output terminal of a jack provided in said seat body, and an input terminal of said jack, into which an external power plug can be inserted into so as to supply electrical power, being extended out of a hole formed in an outer surface of the seat body; and a light guiding unit provided in said seat body including a transparent light-guiding plate provided with a light-facing surface and a light-shadowing surface, a light-diffusing film provided on the light-facing surface for distributing uniformly light, and at least one cavity formed in the transparent light-guiding plate for accommodating said luminous body. With the photoelectron luminescence doorplate constructed as the above, the light is distributed uniformly, soft and not dazzling, when the luminous body employs a LED semiconductor cold light lamp, the service life of the photoelectron luminescence doorplate is long, and the photoelectron luminescence doorplate is energy saving, safe and not scald his hand while a child uses it.

### BACKGROUND OF THE INVENTION

Presently, the widely used doorplate generally comprises a back plate on which numeric representations are provided. Additionally, an illuminating lamp supplied with commercial power is provided at a side of the back plate, so that the number on the doorplate is visible during nighttime. However, the number on the conventional doorplate is invisible during nighttime in case of a power interruption or a power failure caused by an accident fire indoor, in this case, it is difficult for the fire fighters, policemen or rescue workers to identify the number on the doorplate so as to determine the location of the emergency scene, thus delaying the rescue service.

### SUMMARY OF THE INVENTION

An object of the present utility model is to provide a photoelectron luminescence doorplate having chargeable storage batteries provided therein, the photoelectron luminescence doorplate can emit light automatically in case of power interruption so as to be convenient for rescue.

In order to accomplish the above object, the present utility model provides a photoelectron luminescence doorplate, comprising: a seat body; a cover; at least one luminous body provided in the seat body; a set of chargeable storage batteries provided in the seat body; a solar-energy converting sensitive plate flexibly connected to an upper end of the seat body; a drive circuit for the luminous body electrically connected with an output terminal of a jack provided in the seat body, and an input terminal of the jack being extended out of a hole formed in an outer surface of the seat body and capable of being inserted into by an external power plug directly so as to supply electrical power; and a light guiding unit provided in the seat body, the light guiding unit including a transparent light-guiding plate provided with a light-facing surface and a light-shadowing surface, a light-diffusing film provided on the light-facing surface for distributing uniformly light, and at least one cavity formed in the transparent light-guiding plate for accommodating the luminous body.

That is, the present utility model provides a photoelectron luminescence doorplate, comprising a seat body and a cover of transparent material, at least one luminous body is provided in the seat body, a drive circuit for the luminous body is electrically connected with an output terminal of a jack provided in the seat body, and an input terminal of the jack is connected to a power plug at an outer surface of the seat body. A solar-energy converting sensitive plate is provided at an upper end of the seat body and can absorb the sunlight so as to convert the solar energy into electrical energy, then to store the electrical energy in the chargeable storage batteries, so that the chargeable storage batteries can supply electrical power to the luminous body for illumination in case of commercial power interruption. A light guiding unit is provided at an opening of a light-guiding hole, the light guiding unit comprises a transparent light-guiding plate provided with a light-facing surface and a light-shadowing surface, in which the light-facing surface is provided with a light-diffusing film for distributing uniformly light, and at least one cavity is formed in the transparent light-guiding plate for accommodating the luminous body.

Preferably, a light reflecting film is attached to the light-shadowing surface of the light-guiding plate.

Further, a light-shielding film is attached to the light-facing surface of the light-guiding plate.

In addition, light reflecting films are provided on side surfaces of the light-guiding plate.

Preferably, the luminous body comprises a LED semiconductor cold light lamp.

Further, the set of chargeable storage batteries are charged by means of a commercial power or the solar-energy converting sensitive plate.

The set of chargeable storage batteries can supply electrical power to the photoelectron luminescence doorplate in case of emergency and commercial power interruption.

In addition, an angle of the solar-energy converting sensitive plate is adjustable.

In the photoelectron luminescence doorplate according to the present utility model, the light-shadowing surface and the side surfaces of the light-guiding plate all provided with light reflecting films, so that all the light radiated by the luminous body is emitted through the light-facing surface of the light-guiding plate, while the light-facing surface of the light-guiding plate is provided with a light-diffusing film thereon, in which the light-diffusing film makes the light to be distributed uniformly, soft and not dazzling. When the luminous body employs a LED semiconductor cold light lamp, not only the service life of the photoelectron luminescence doorplate is long, but also the photoelectron luminescence doorplate will not scald his hand while a child uses it.

### BRIEF DESCRIPTION OF THE DRAWING

FIG. 1 is a front view of the photoelectron luminescence doorplate;

FIG. 2 is a cross sectional view of the photoelectron luminescence doorplate in FIG. 1;

FIG. 3 is a rear view of the photoelectron luminescence doorplate in FIG. 1;

FIG. 4 is a side view of the photoelectron luminescence doorplate in FIG. 1;

FIG. 5 is another side view of the photoelectron luminescence doorplate in FIG. 1, showing the solar-energy converting sensitive plate whose angle can be adjusted;

FIG. 6 is a bottom view of the photoelectron luminescence doorplate in FIG. 1;

FIG. 7 is a tope view of the photoelectron luminescence doorplate in FIG. 1;

FIG. 8 is a schematic perspective front view showing the structure of the photoelectron luminescence doorplate in FIG. 1.

### DESCRIPTION OF THE PREFERRED EMBODIMENTS

A preferred embodiment of the present utility model will be described in detail with reference to the drawings.

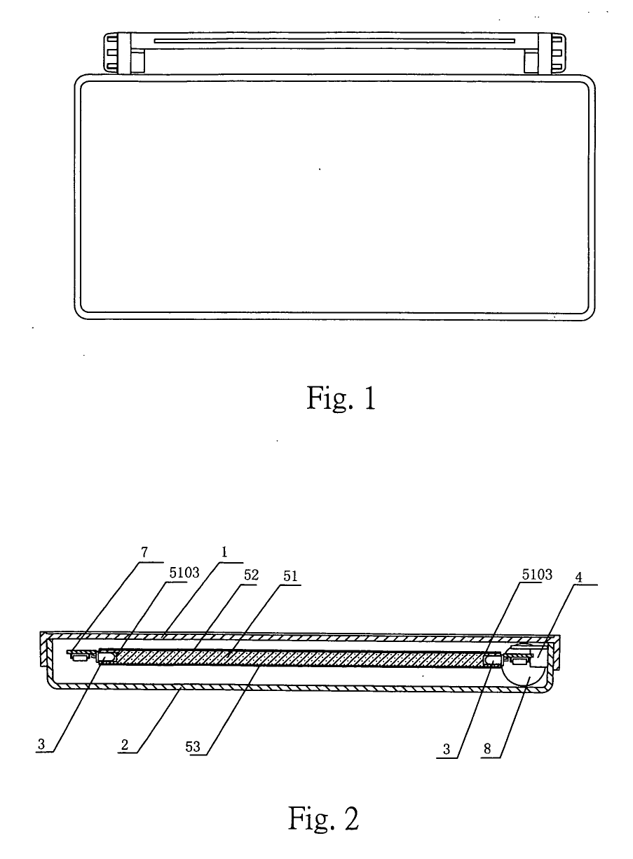

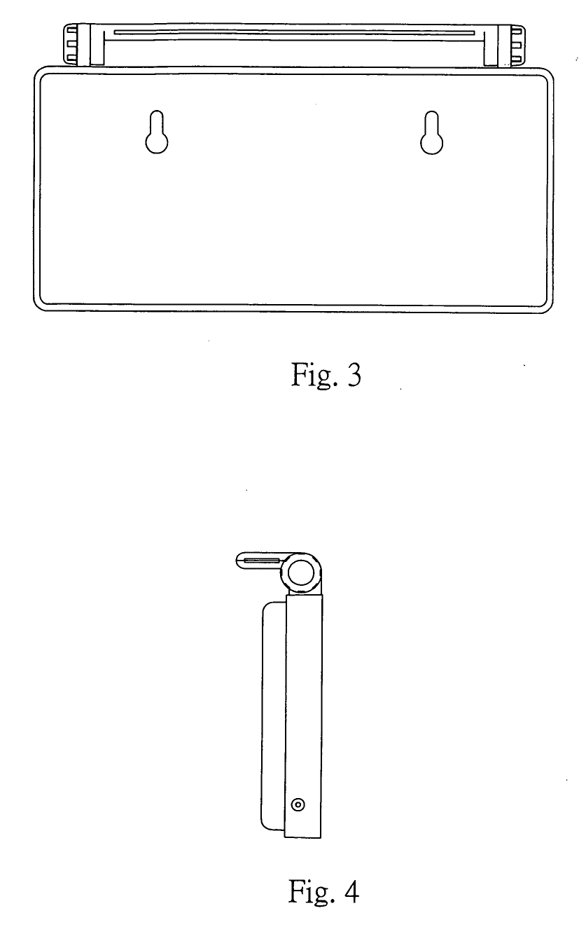

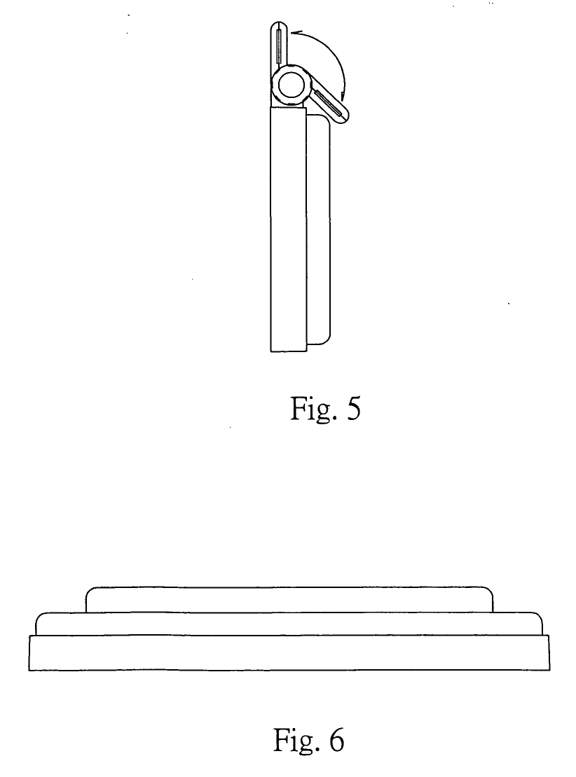

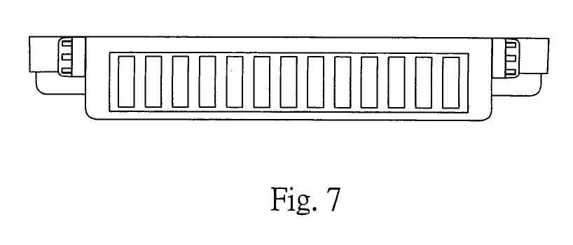

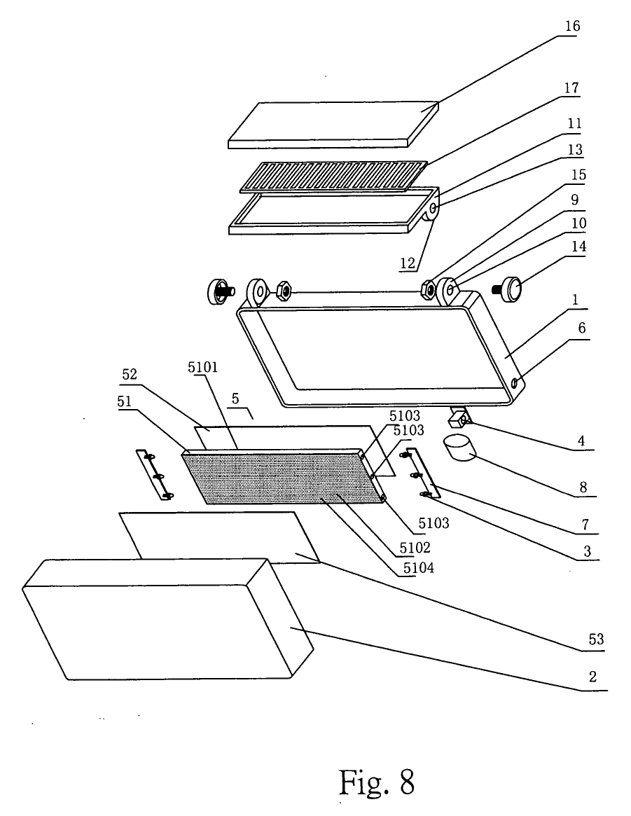

As shown in FIG. 1, a photoelectron luminescence doorplate comprises a seat body 1 and a cover 2, the cover 2 is formed of a transparent material; at least one luminous body 3 is provided in the seat body 1, the number of the luminous body 3 can be selected according to various requirements of application and different colors, for example, three luminous bodies 3 are provided in the seat body 1 for emitting yellow, blue and white light respectively, the luminous body 3 can employ a general incandescent lamp, in the present utility model, the luminous body 3 employs a LED semiconductor cold light lamp, the LED semiconductor cold light lamp has a low power consumption, a long service life and does not generate heat, so that it can be used safely without scalding a child's hand during nighttime, a drive circuit of the luminous body 3 is electrically connected with an output terminal of a jack 4 provided in the seat body 1, and an input terminal of the jack 4 is extended out of a hole 6 formed in an outer surface of the seat body 1, an external power plug can be directly inserted into the input terminal of the jack 4 for supplying electric power. The luminous bodies 3 are arranged in order so as to be fixed on a circuit board 7; a set of chargeable storage batteries 8 are provided at a lower end of the jack 4, the chargeable storage batteries 8 are used to supply electrical energy to the luminous body 3 for luminescence in an emergency such as commercial power interruption. A light guiding unit 5 is provided at an inner surface of the cover 2, as shown in FIG. 2. The light guiding unit 5 guides uniformly the light emitted by the luminous body 3 outward, and comprises a transparent light-guiding plate 51, a light reflecting film 52 and a light-shielding film 53. At least one cavity 5103 is formed in the transparent light-guiding plate 51 for encasing the luminous body 3 therein. In the present embodiment, there are provided with six cavities 5103, the six cavities 5103 are used to encase luminous bodies 3 which emit light of three colors, respectively. The transparent light-guiding plate 51 has a light-facing surface 5101 and a light-shadowing surface 5102 opposed to each other, a light-diffusing film 5104 is attached to the light-facing surface 5101 so as to distribute uniformly the light emitted by the luminous body 3. In order to enhance the comfortableness of the light during nighttime, the light-shielding film 53 is attached to an outer surface of the light-diffusing film 5104.

For the light guiding unit 5 employed in the photoelectron luminescence doorplate of the present utility model, a transparent material, which can distribute the light and guide the light outward uniformly, can be directly substituted for the transparent light-guiding plate 51, so that the light-diffusing film 5104 is not necessary. The light-shadowing surface and side surfaces of the transparent light-guiding plate 51 can be coated with light reflecting films 52 directly.

The seat body 1 is provided with two lugs 9 at an upper end thereof, each of the lugs 9 is formed centrally with a rotation shaft hole 10, an inner surface of each lug 9 is clung to an outer surface of each of two connection shafts 12, the two connection shafts 12 are provided at a lower end of a lower cover 11 for solar-energy converting sensitive plate, and each of the two connection shafts 12 are formed centrally with a rotation shaft hole 13. It is apparent that a screw 14 may be inserted through the rotation shaft hole 10 of the seat body 1 and the rotation shaft hole 13 of the sequentially and then engaged with a nut 15, so that an angle of the lower cover 11 for solar-energy converting sensitive plate can be adjusted so as to provide an optimum angle for receiving the sunlight. The lower cover 11 for solar-energy converting sensitive plate is connected at the upper end thereof to an upper cover 16 for solar-energy converting sensitive plate, the upper cover 16 for solar-energy converting sensitive plate is formed of a transparent material, an inner surface of the upper cover 16 for solar-energy converting sensitive plate is clung to a solar-energy converting sensitive plate 17, the solar-energy converting sensitive plate 17 can collect the sunlight and convert the solar energy into electrical energy, then store the electrical energy into the chargeable storage batteries 8.

The photoelectron luminescence doorplate of the present utility model is an illumination product which is safe, energy-saving and environment friendly. In use, the user can cling his doorplate to the outer surface of the cover 2, so that the number on the doorplate is visible from a far location so as to be convenient for a guest to identify during nighttime. In an emergency, it is convenient for salvager to identify the number on the doorplate so as to determine the location of the emergency scene without delaying. Therefore, the photoelectron luminescence doorplate of the present utility model is necessary for household.

What is claimed is:

1. A photoelectron luminescence doorplate comprising:
a seat body; a cover; at least one luminous body provided in said seat body; a set of chargeable storage batteries provided in said seat body; a solar-energy converting sensitive plate flexibly connected to an upper end of said seat body; a drive circuit for said luminous body electrically connected with an output terminal of a jack provided in said seat body, and an input terminal of said jack being extended out of a hole formed in an outer surface of the seat body; and a light guiding unit provided in said seat body, the light guiding unit including a transparent light-guiding plate provided with a light-facing surface and a light-shadowing surface, a light-diffusing film provided on the light-facing surface for distributing uniformly light, and at least one cavity formed in the transparent light-guiding plate for accommodating said luminous body.

2. The photoelectron luminescence doorplate according to the claim 1, wherein a light reflecting film is attached to said light-shadowing surface of said light-guiding plate.

3. The photoelectron luminescence doorplate according to the claim 1, wherein a light-shielding film is attached to said light-facing surface of said light-guiding plate.

4. The photoelectron luminescence doorplate according to the claim 3, wherein light reflecting films are provided on side surfaces of said light-guiding plate.

5. The photoelectron luminescence doorplate according to the claim 4, wherein said luminous body comprises a LED semiconductor cold light lamp.

6. The photoelectron luminescence doorplate according to the claim 3, wherein said set of chargeable storage batteries are charged by means of a commercial power or said solar-energy converting sensitive plate.

7. The photoelectron luminescence doorplate according to the claim 1, wherein an angle of said solar-energy converting sensitive plate is adjustable.
